(19) United States
(12) Patent Application Publication
(10) Pub. No.: US 2008/0241536 A1
(43) Pub. Date: Oct. 2, 2008

(54) Method for processing cellulose in ionic liquids and fibers therefrom

(75) Inventors: Mengkui Luo, Auburn, WA (US); Hugh West, Seattle, WA (US); Amar N. Neogi, Kenmore, WA (US)

Correspondence Address: WEYERHAEUSER COMPANY;INTELLECTUAL PROPERTY DEPT., CH 1J27, P.O. BOX 9777, FEDERAL WAY, WA, 98063, US

(73) Assignee: Weyerhaeuser Co., Federal Way, WA (US)

(21) Appl. No.: 11/693,062

(22) Filed: Mar. 29, 2007

(51) Int. Cl. B32B 23/00; D21C 9/00

(52) U.S. Cl. 428/393; 162/55

(57) ABSTRACT

The present application is directed to a process of dissolving cellulose in an ionic liquid, regenerating the fibers and forming a nonwoven web. In particular it is directed to fibers produced from cellulose dissolved in ionic solvents and extruded by the meltblowing process. Bonded nonwoven webs can be obtained in the process.

### FIELD

The present application relates to a method for processing cellulose in ionic liquids and the fibers obtained therefrom.

### BRIEF DESCRIPTION OF THE DRAWINGS

FIG. 1 is a scanning electron photomicrograph at 1000× of the cross section of cellulose fibers from bleached pulp Sample 8.

FIG. 2 is a scanning electron photomicrograph at 100× of cellulose fibers from bleached Sample 8 in a nonwoven web.

FIG. 3 is a scanning electron photomicrograph at 1000× of the cross section of cellulose fibers from unbleached pulp Sample 11.

FIG. 4 is a scanning electron photomicrograph at 100× of cellulose fibers from unbleached pulp Sample 11 in a nonwoven web.

### DESCRIPTION

The present application is directed to a process of dissolving cellulose in an ionic liquid regenerating the fibers and forming a nonwoven web. In particular it is directed to fibers produced from cellulose dissolved in ionic solvents and extruded by the meltblowing process. By meltblowing it is understood to refer to a process that is similar or analogous to the process used for production of thermoplastic fibers, even though the cellulose is in solution and the spinning temperature is only moderately elevated.

As the current world demand for cellulose in textiles increases, there is an increasing demand for low cost raw materials which can be used in commercial processes that use these raw materials. Additionally, there is a need to develop new processes which use these raw materials and which are simpler, have less of an environmental impact and do not have some of the shortcomings of the current processes.

In the viscose process cellulose is first steeped in a mercerizing strength caustic soda solution to form an alkali cellulose. This is reacted with carbon disulfide to form cellulose xanthate which is then dissolved in dilute caustic soda solution. After filtration and deaeration the xanthate solution is extruded from submerged spinnerets into a regenerating bath of sulfuric acid, sodium sulfate, zinc sulfate, and glucose to form continuous filaments. The resulting viscose rayon is presently used in textiles and has been used in such applications as tires and drive belts.

Cellulose is also soluble in a solution of ammonia copper oxide. This property forms the basis for production of cuprammonium rayon. The cellulose solution is forced through submerged spinnerets into a solution of 5% caustic soda or dilute sulfuric acid to form the fibers, which are then decoppered and washed. Cuprammonium rayon can be available in fibers of very low deniers and is used almost exclusively in nonwoven wipe application.

The foregoing processes for preparing rayon both require that the cellulose be chemically derivatized or complexed in order to render it soluble and therefore capable of being spun into fibers. In the viscose process, the cellulose is derivatized, while in the cuprammonium rayon process, the cellulose is complexed. In either process, the derivatized or complexed cellulose must be regenerated and the reagents that were used to solubilize it must be removed. The derivatization and regeneration steps in the production of rayon significantly add to the cost of this form of cellulose fiber and also possess environmental issues in the use of zinc in coagulation baths and in the handling of carbon disulfide. Consequently, in recent years attempts have been made to identify solvents that are capable of dissolving underivatized cellulose to form a (or solution) of underivatized cellulose from which fibers can be spun.

One class of organic solvents useful for dissolving cellulose are the amine-N oxides, in particular the tertiary amine-N oxides.

Lyocell is a generic term for a fiber composed of cellulose precipitated from an organic solution in which no substitution of hydroxyl groups takes place and no chemical intermediates are formed. Several manufacturers presently produce lyocell fibers, principally for use in the textile industry. For example, Lenzing, Ltd. presently manufactures and sells a lyocell fiber called Tencel® fiber.

Currently available lyocell fibers and high performance rayon fibers are produced from high quality wood pulps that have been extensively processed to remove non-cellulose components, especially hemicellulose. These highly processed pulps are referred to as dissolving grade or high α (high alpha) pulps, where the term a refers to the percentage of cellulose remaining after extraction with 17.5% caustic.

Alpha cellulose can be determined by TAPPI 203. Thus, a high alpha pulp contains a high percentage of cellulose, and a correspondingly low percentage of other components, especially hemicellulose. The processing required to generate a high alpha pulp significantly adds to the cost of rayon and lyocell fibers and products manufactured therefrom. Typically, the cellulose for these high alpha pulps comes from both hardwoods and softwoods; softwoods generally have longer fibers than hardwoods.

Since conventional Kraft processes stabilize residual hemicelluloses against further alkaline attack, it is not possible to obtain acceptable quality dissolving pulps, i.e., high alpha pulps, through subsequent treatment of Kraft pulp in the bleaching stages. A relatively low copper number, reflective of the relative carbonyl content of the cellulose, is a desirable property of a pulp that is to be used to make lyocell fibers because it is generally believed that a high copper number causes cellulose and solvent degradation, before, during, and/or after dissolution in an amine oxide solvent. The degraded solvent can either be disposed of or regenerated, however, due to its cost it is generally undesirable to dispose of the solvent.

A low transition metal content is a desirable property of a pulp that is to be used to make lyocell fibers because, for example, transition metals accelerate the undesirable degradation of cellulose and NMMO in the lyocell process

Dissolution of cellulose in the lyocell process and regeneration of the solvent suffers from the drawback that these regeneration processes involve dangerous, potentially explosive conditions.

In view of the expense of producing commercial dissolving grade pulps, it is desirable to have alternatives to conventional high alpha dissolving grade pulps as a rayon or lyocell raw material.

Thus, there is a need for relatively inexpensive, low alpha (e.g., high yield) pulps that can be used to make rayon, lyocell fibers or regenerated cellulose fibers. Preferably, the desired low alpha pulps will have a desirably low copper number, a desirably low lignin content and a desirably low transition metal content but broad molecular weight distribution.

Pulps which meet these requirements have been made and are described in U.S. Pat. No. 6,797,113, U.S. Pat. No. 6,686,093 and U.S. Pat. No. 6,706,876, the assignee of the present application. While high purity pulps are also suitable for use in the present application, low cost pulps such as Peach®, Grand Prairie Softwood and C-Pine, all available from Weyerhaeuser are suitable. These pulps provide the benefit of lower cost and better bonding for nonwoven textile applications because of their high hemicellulose content. Selected pulp properties are given in Table 1.

TABLE 1
Pulp Properties

| Pulp | R₁₀ | R₁₈ | % Xylan | % Mannan | α-cellulose |
|---|---|---|---|---|---|
| Peach | 85 | 88 | | | 86 |
| Grand Prairie | | 19* | 7.59 | 6.2 | |
| Softwood | | | | | |
| C-Pine | 87.4 | 88.0* | 7.50 | 5.86 | |

*18% Solubitity by TAPPI T235

Additionally, however, there is a need to develop new processes which use a broad spectrum of raw materials, including high purity pulp, where derivatization of the cellulose is not necessary, which are simpler, have less of an environmental impact and do not have some of the shortcomings of the current processes.

The type of cellulosic raw material used with the present application is not critical. It may be bleached or unbleached wood pulp which can be made by various processes of which kraft, prehydrolyzed kraft, or sulfite are exemplary. Many other cellulosic raw materials, such as purified cotton linters, are equally suitable. Prior to dissolving in the ionic liquid the cellulose, if sheeted, is normally shredded into a fine fluff to promote ready solution. Bleached pulp from both hardwoods and softwoods can be used with widely ranging fiber properties. In one embodiment the pulp has a D.P range of from about 150 to 3000. In another embodiment the D.P is from about 350 to about 900 and in yet another embodiment the D. P. is from about 400 to about 800. As defined herein degree of polymerization (abbreviated as D.P.) refers to the number of anhydro-D-glucose units in the cellulose chain. D.P. was determined by ASTM Test 1795-96. Pulp with the above properties can be dissolved in the ionic liquids over a range from about 1 percent by weight cellulose in ionic liquid to about 35 percent by weight in ionic liquid. In one embodiment the pulp is dissolved in the ionic liquid at a weight of from about 5 percent by weight to about 30 percent by weight. In another embodiment to pulp is dissolved in the ionic liquid of from about 10 percent by weight to about 15 by weight.

The term hemicellulose refers to a heterogeneous group of low molecular weight carbohydrate polymers that are associated with cellulose in wood. Hemicelluloses are amorphous, branched polymers, in contrast to cellulose which is a linear polymer. The principal, simple sugars that combine to form hemicelluloses are: D-glucose, D-xylose, D-mannose, L-arabinose, D-galactose, D-glucuronic acid and D-galacturonic acid.

Hemicellulose was measured in the pulp and in the fiber by the method described below for sugar analysis and represents the sum of the xylan and mannan content of the pulp or fiber. In one embodiment the pulp contains from 3.0 to 18% by weight hemicellulose as defined by the sum-of the xylan and mannan content of the pulp. In another embodiment the pulp contains from 7 to 14% by weight hemicellulose and in yet another embodiment the pulp contains from 9% to 12 percent by weight hemicellulolse.

As used in this application one method for measuring the degraded shorter molecular weight components in the pulp is by the R₁₈ and R₁₀ content is described in TAPPI 235. R₁₀ represents the residual undissolved material that is left extraction of the pulp with 10 percent by weight caustic and R₁₈ represents the residual amount of undissolved material left after extraction of the pulp with an 18% caustic solution. Generally, in a 10% caustic solution, hemicellulose and chemically degraded short chain cellulose are dissolved and removed in solution. In contrast, generally only hemicellulose is dissolved and removed in an 18% caustic solution. Thus, the difference between the R₁₀ value and the R₁₈ value, (ΔR=R₁₈−R₁₀), represents the amount of chemically degraded short chained cellulose that is present in the pulp sample. In one embodiment the pulp has a ΔR from about 2 to a ΔR of about 10. In another embodiment the ΔR is from about 4 to a ΔR of about 6.

Lignin is a complex aromatic polymer and comprises about 15% to 30% of wood where it occurs as an amorphous polymer. Lignin was measured by the method described in TAPPI 222. Lignin content in the unbleached pulp used in the present application ranges from about 0.1 percent by weight to 25 percent by weight in the pulp. In another embodiment the lignin can be from 3 percent by weight to about 16 percent by weight and in yet another embodiment it can be from about 7 percent by weight to about 10 percent by weight.

When using ionic liquids the cellulose raw material can have a higher copper number and a higher transitional metal content than those for lyocell due to the higher solvent thermal stability of ionic liquids.

In the method, cellulose is dissolved in an ionic liquid. Ionic liquids are ionic compounds which are liquid below 100° C. as defined in this application. More commonly, ionic liquids have melting points below room temperatures, some even below 0° C. The compounds are liquid over a wide temperature range from the melting point to the decomposition temperature of the ionic liquid. Examples of the cation moiety of ionic liquids are cations from the group consisting of cyclic and acyclic cations. Cyclic cations include pyridinium, imidazolium, and imidazole and acyclic cations include alkyl quaternary ammomnium and alkyl quaternary phosphorous cations. Counter anions of the cation moiety are selected from the group consisting of halogen, pseudohalogen and carboxylate. Carboxylates include acetate, citrate, malate, maleate, formate, and oxylate and halogens include chloride, bromide, zinc chloride/choline chloride, 3-methyl-N-butyl-pyridinium chloride and benzyldimethyl (tetradecyl) ammonium chloride. Substituent groups, (i.e. R groups), on the cations can be C₁, C₂, C₃, and C₄ these can be saturated or unsaturated. Examples of compounds which are ionic liquids include, but are not limited to, 1-ethyl-3-methyl imidazolium chloride, 1-ethyl-3-methyl imidazolium acetate, 1-butyl-3-methyl imidazolium chloride, 1-ally-3-methyl imidazolium chloride, zinc chlortide, /choline chloride, 3-methyl-N-butyl-pyridinium chloride, benzyldimethyl(tetradecyl)ammonium chloride and 1-methylimidazolehydrochloride. The 1-ethyl-3-methyl imidazolium acetate used in this work was obtained from Sigma Aldrich, Milwaukee.

Cellulose dissolved in the ionic liquid can be regenerated by precipitating the ionic liquid solution with a liquid non-solvent for the cellulose that is miscible with the ionic liquid. Preferably the liquid non-solvent is miscible with water but other non-solvents such methanol, ethanol, acetonitrile, an ether such as furan or dioxane or a ketone can be used. The advantage of water is that the process avoids the use of a volatile organic compound and regeneration does not require the use of volatile organic solvents. Thus the ionic liquid can be dried and reused after regeneration. In one embodiment water is used as the non-solvent for regeneration of the cellulose. Mixtures of from 0% by weight non-solvent/solvent to about 50% by weight non-solvent/solvent can be used for regenerating the cellulose from the ionic liquid solution. For example, up to a 50% by weight water and 50% by weight 1-ethyl-3-methyl imidazolium acetate can be used in the regeneration process.

Cellulose dissolved in the ionic liquid can be spun by various processes. In one embodiment it is spun by the meltblown process. In another embodiment it is spun by the centrifugal spinning process, in another embodiment it is spun by the dry-jet-wet process and in yet another it is spun by the spun bonding process. Fibers formed by the meltblown process can be continuous or discontinuous depending on air velocity, air pressure, air temperature, viscosity of the solution, D.P. of the cellulose and combinations thereof; in the continuous process the fibers are taken up by a reel and optionally stretched. In one embodiment for making the nonwoven web the fibers are contacted with a non solvent such as water by spraying, subsequently taken up on a moving foraminous support, washed and dried. The fibers formed by this method can be in a bonded nonwoven web depending on the extent of coagulation or if it is spunlaced. Spunlacing involves impingement with a water jet. A somewhat similar process is called “spunbonding” where the fiber is extruded into a tube and stretched by an air flow through the tube caused by a vacuum at the distal end. In general, spunbonded fibers are longer than meltblown fibers which usually come in discrete shorter lengths. Another process, termed “centrifugal spinning”, differs in that the polymer is expelled from apertures in the sidewalls of a rapidly spinning drum. The fibers are stretched somewhat by air resistance as the drum rotates. However, there is not usually a strong air stream present as in meltblowing. The other technique is dry jet/wet. In this process the filaments exiting the spinneret orifices pass through an air gap before being submerged and coagulated in a liquid bath. All four processes may be used to make nonwoven webs.

Solution, pulp and fiber properties are given in Table 2.

Example 1 is a representative method for preparing and spinning the solution of cellulose in ionic liquid.

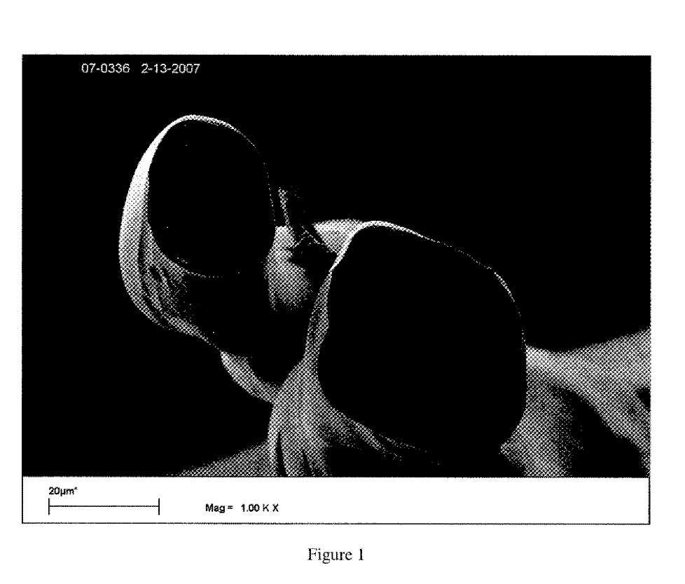

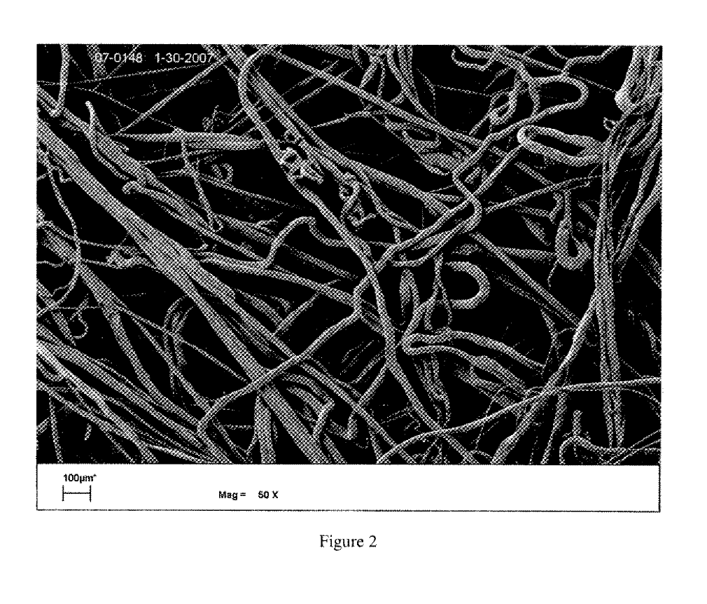

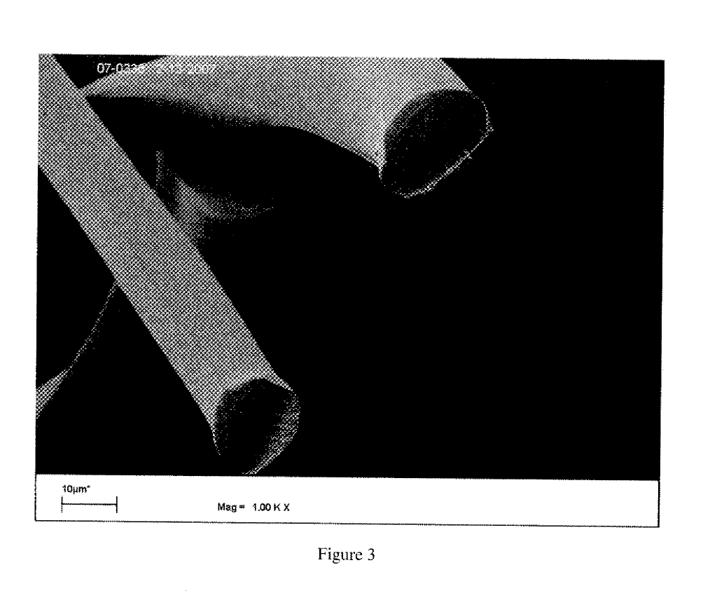

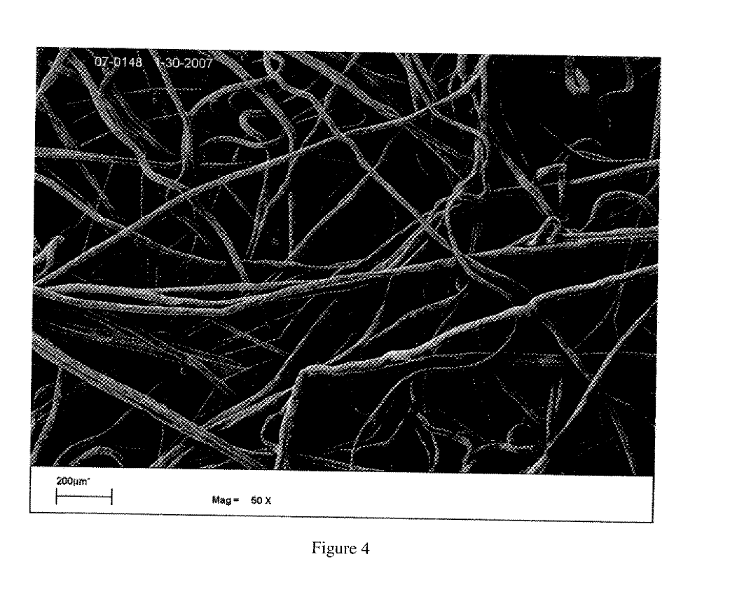

Fibers from the meltblown ionic solutions containing cellulose from bleached and unbleached pulp show a wide range of properties. FIG. 1 is a scanning electron micrograph of the cross section of cellulose fibers from bleached pulp indicating a rounded cross section. FIG. 2 is a scanning electron micrograph of the nonwoven web of cellulose fibers from bleached pulp with bonding between some of the cellulose fibers. FIG. 3 is a scanning electron micrograph of the cross section of cellulose fibers from unbleached pulp also indicating a rounded cross section. FIG. 4 is a scanning electron micrograph of the non woven web of fibers from unbleached pulp with bonding between some of the cellulose fibers.

In one embodiment the D.P. of the fibers is from about 150 to 3000. In another embodiment the D.P is from about 350 to about 900 and in yet another embodiment the D. P. is from about 400 to about 800.

In one embodiment the fibers contain from about 3.0 to 18% by weight hemicellulose as defined by the sum of the xylan and mannan content of the fibers. In another embodiment the fibers contains from 7 to 14% by weight hemicellulose and in yet another embodiment the fibers contain from 9% to 12 percent by weight hemicellulose.

Depending on a number of factors such as air velocity, air pressure, air temperature, viscosity of the solution, D.P. of the cellulose and combinations thereof, a wide range of fiber properties can be obtained by the meltblowing process. In one embodiment the fibers have a fiber diameter of from about 3μ to about 40μ. In another embodiment the fibers have a fiber diameter of from about 10 to about 25 μand in yet another embodiment the fibers have a fiber diameter of from about 15 to about 20μ. Fiber diameter measurements represent the average diameter of 100 randomly selected fibers and measurement with a light microscope.

Birefringence of both the bleached and unbleached fibers indicates a high degree of molecular orientation of the cellulose fibers. In one embodiment the fibers the birefringence value is from 0.01 to about 0.05. In another embodiment the birefringence value is from 0.015 to about 0.035 and in yet another embodiment the birefringence is from 0.020 to about 0.030. Birefringence was determined by the method described below.

Lignin content in the fiber from unbleached pulp is slightly lower than in the pulp. In one embodiment the lignin ranges from about 0.1 percent by weight to 25 percent by weight in the fiber. In another embodiment the lignin is from about 3 percent by weight to about 16 percent by weight and in yet another embodiment it can be from about 7 percent by weight to about 10 percent by weight.

TABLE 2
Solution, Pulp And Fiber Properties

| | | | | | | Process | | | | | | | |
|---|---|---|---|---|---|---|---|---|---|---|---|---|---|
| Solution | Pulp | | | | | Soln., | | Fiber Properties | | | | | |
| Cellulose | | R10, | R18, | Xylan, | | Air, | Air, | | | | Lignin | | |
| Wt % | DP | % | % | % | Mannan, % | ° C. | psi | Diameter μ | Xylan, % | Mannan, % | Wt % | Δn** | Sample |
| 21.2 | 420 | 77 | 87 | 6.5 | 5.5 | 105 | 10 | 36.2 | 5.7 | 4.6 | | 0.034 | 1 |
| 21.2 | 420 | 77 | 87 | 6.5 | 5.5 | 105 | 20 | 10.0 | 5.7 | 4.5 | | 0.022 | 2 |
| 12.0* | 760 | 83 | 87 | 6.7 | 5.2 | 105 | 5 | 33.7 | 5.7 | 4.6 | | | 3 |
| 12.0* | 760 | 83 | 87 | 6.7 | 5.2 | 105 | 15 | 12.5 | 5.8 | 4.5 | | 0.026 | 4 |
| 10.0 | 760 | 83 | 87 | 6.7 | 5.2 | 100 | 10 | 21.7 | 5.2 | 4.6 | | | 5 |
| 10.0 | 760 | 83 | 87 | 6.7 | 5.2 | 100 | 15 | 13.2 | 5.4 | 4.7 | | | 6 |
| 12.0 | 760 | 83 | 87 | 6.7 | 5.2 | 105 | 5 | 25.0 | 5.5 | 4.6 | | | 7 |
| 12.0 | 760 | 83 | 87 | 6.7 | 5.2 | 95 | 10 | 12.5 | 5.6 | 4.5 | | 0.046 | 8 |
| 12.0*** | 720 | 81.4 | 84.8 | 5.5 | 7.3 | 95 | 10 | 21.0 | 4.7 | 6.3 | 3.3 | | 9 |
| 12.0*** | 720 | 81.4 | 84.8 | 5.5 | 7.3 | 80 | 15 | 10.5 | | | | | 10 |
| 12.0*** | 720 | 81.4 | 84.8 | 5.5 | 7.3 | 90 | 5 | 23.1 | | | | 0.020 | 11 |

1-ethyl-3-methylimidazolium acetate was used as the ionic liquid for all samples Soln. refers to solution of cellulose in ionic liquid
*1% by wt, propyl gallate based on pulp to chelate transition metals
**birefringence
***lignin in unbleached pulp Samples 9, 10 and 11 is 3.5% by weight in pulp.

### EXAMPLE 1

A solution for forming filaments was made by dissolving a Kraft pulp, Peach®, having an average degree of polymerization of about 760 and a hemicellulose content of about 12% in 1-ethyl-3-methiylimidazolium acetate at 105° C. with stirring. The cellulose concentration in the solution was about 12% by weight. The solution was extruded from a melt blowing die that had 3 nozzles having an orifice diameter of 457 microns at a rate of 1.0 gram/hole/minute. The orifices had a length/diameter ratio of 5. The nozzle was maintained at a temperature of 95° C. The solution was extruded into an air gap 30 cm long before coagulation in water and collected on a screen as continuous filaments. Air, at a temperature of 95° C. and a pressure of about 10 psi, was supplied to the head.

### Birefringence of Fibers by Polarized Light Microscopy

In theory, fibers can be characterized as having an index of refraction parallel (axial) to the fiber axis and an index of refraction which is perpendicular to the fiber axis. The birefringence for purposes of this method is the difference between these two refractive indices. The convention is to subtract the perpendicular R.I. (refractive index) from the axial R.I. The axial R.I. is typically represented by the Greek letter ω, and the perpendicular index by the letter ε. The birefringence is typically represented as Δ=(ω−ε).

### Refractive Index Oils

Oils are manufactured with known refractive index at a given wavelength of exciting light and at a given temperature. The fibers were compared to Cargile refractive index oils.

### Polarized Light

Using transmitted light in the light microscope, the refractive index is measured using a polarizing filter. When the exciting light is polarized in a direction parallel to the axis of the fiber the axial refractive index can be measured. Then the polarizing filter can be rotated 90 degrees and the refractive index measured perpendicular to the fiber axis.

### Measurement Using the Light Microscope

When the refractive index of the fiber matches the refractive index of the oil in which it is mounted, the image of the fiber will disappear. Conversely, when the fiber is mounted in an oil which greatly differs in refractive index, the image of the fiber is viewed with high contrast.

When the R.I. of the fiber is close to the R.I. of the oil, a technique is used to determine whether the fiber is higher or lower in refractive index. First the fiber, illuminated with the appropriately positioned polarizing filter, is brought into sharp focus in the microscope using the stage control. Then the stage is raised upward slightly. If the image of the fiber appears brighter as the stage is raised, the fiber is higher in refractive index than the oil. Conversely if the fiber appears darker as the stage is raised, the fiber is lower in refractive index than the oil.

Fibers are mounted in R.I. oils and examined until a satisfactory match in refractive index is obtained. Both the axial and the perpendicular component are determined and the birefringence is calculated.

### Sugar Analysis

This method is applicable for the preparation and analysis of pulp and wood samples for the determination of the amounts of the following pulp sugars: fucose, arabinose, galactose, rhamnose, glucose, xylose and mannose using high performance anion exchange chromatography and pulsed amperometric detection (HPAEC/PAD).

### Summary Of Method

Polymers of pulp sugars are converted to monomers by hydrolysis using sulfuric acid. Samples are ground, weighed, hydrolyzed, diluted to 200-mL final volume, filtered, diluted again (1.0 mL+8.0 mL H₂O) in preparation for analysis by HPAEC/PAD.

### Sampling, Sample Handling and Preservation

Wet samples are air-dried or oven-dried at 25±5° C.

### Equipment Required

### Autoclave, Market Forge, Model # STM-E, Serial # C-1808

100×10 mL Polyvials, septa, caps, Dionex Cat # 55058
Gyrotory Water-Bath Shaker, Model G76 or some equivalent.
Balance capable of weighing to ±0.01 mg, such as Mettler HL52 Analytical Balance. Intermediate Thomas-Wiley Laboratory Mill, 40 mesh screen.
NAC 1.506 vacuum oven or equivalent.
0.45-μ. GHP filters, Gelman type A/E, (4.7-cm glass fiber filter discs, without organic binder)
Heavy-walled test tubes with pouring lip, 2.5×20 cm.

### Comply SteriGage Steam Chemical Integrator

GP 50 Dionex metal-free gradient pump with four solvent inlets
Dionex ED 40 pulsed amperornetric detector with gold working electrode and solid state reference electrode
Dionex autosampler AS 50 with a thermal compartment containing the columns, the ED 40 cell and the injector loop
Dionex PC10 Pneumatic Solvent Addition apparatus with 1-L plastic bottle
3 2-L Dionex polyethylene solvent bottles with solvent outlet and helium gas inlet caps
CarboPac PA1 (Dionex P/N 035391) ion-exchange column, 4 mm×250 mm
CarboPac PA1 guard column (Dionex P/N 043096), 4 mm×50 mm
Millipore solvent filtration apparatus with Type HA 0.45u filters or equivalent

### Reagents Required

All references to H₂O is Millipore H₂O

72% Sulfuric Acid Solution (H2SO4)—Transfer 183 mL of water into a 2-L Erlenmeyer flask. Pack the flask in ice in a Rubbermaid tub in a hood and allow the flask to cool. Slowly and cautiously pour, with swirling, 470 mL of 96.6% H₂SO₄ into the flask. Allow solution to cool. Carefully transfer into the bottle holding 5-mL dispenser. Set dispenser for 1 mL.

JT Baker 50% sodium hydroxide solution, Cat. No. Baker 3727-01, [1310-73-2]
Dionex sodium acetate, anhydrous (82.0±0.5 grams/1 L H₂O), Cat. No. 59326, [127-09-3].

### Standards

### Internal Standards

Fucose is used for the kraft and dissolving pulp samples. 2-Deoxy-D-glucose is used for the wood pulp samples.
Fucose, internal standard. 12.00±0.005 g of Fucose, Sigma Cat. No. F 2252, [12438-80-4], is dissolved in 200.0 mL H₂O giving a concentration of 60.00±0.005 mg/mL. This standard is stored in the refrigerator.
2-Deoxy-D-glucose, internal standard. 12.00±0.005 g of 2-Deoxy-D-glucose, Fluka Cat. No. 32948 g [101-77-9] is dissolved in 200.0 mL H₂O giving a concentration of 60.00 ±0.005 mg/mL. This standard is stored in the refrigerator.

### Kraft Pulp Stock Standard Solution

KRAFT PULP SUGAR STANDARD CONCENTRATIONS

| Sugar | Manufacturer | Purity | g/200 mL |
|---|---|---|---|
| Arabinose | Sigma | 99% | 0.070 |
| Galactose | Sigma | 99% | 0.060 |
| Glucose | Sigma | 99% | 4.800 |
| Xylose | Sigma | 99% | 0.640 |
| Mannose | Sigma | 99% | 0.560 |

### Kraft Pulp Working Solution

Weigh each sugar separately to 4 significant digits and transfer to the same 200-mL volumetric flask. Dissolve sugars in a small amount of water. Take to volume with water, mix well, and transfer contents to two clean, 4-oz. amber bottles. Label and store in the refrigerator. Make working standards as in the following table.

PULP SUGAR STANDARD CONCENTRATIONS FOR KRAFT PULPS

| | | mL/200 mL | mL/200 mL | mL/200 mL | mL/200 mL | mL/200 mL |
|---|---|---|---|---|---|---|
| Fucose | | 0.70 | 1.40 | 2.10 | 2.80 | 3.50 |
| Sugar | mg/mL | ug/mL | ug/mL | ug/mL | ug/mL | ug/mL |
| Fucose | 60.00 | 300.00 | 300.00 | 300.00 | 300.00 | 300.00 |
| Arabinose | 0.36 | 1.2 | 2.5 | 3.8 | 5.00 | 6.508 |
| Galactose | 0.30 | 1.1 | 2.2 | 3.30 | 4.40 | 5.555 |
| Glucose | 24.0 | 84 | 168.0 | 252.0 | 336.0 | 420.7 |
| Xylose | 3.20 | 11 | 22.0 | 33.80 | 45.00 | 56.05 |
| Mannose | 2.80 | 9.80 | 19.0 | 29.0 | 39.0 | 49.07 |

### Dissolving Pulp Stock Standard Solution

DISSOLVING PULP SUGAR STANDARD CONCENTRATIONS

| Sugar | Manufacturer | Purity | g/100 mL |
|---|---|---|---|
| Glucose | Sigma | 99% | 6.40 |
| Xylose | Sigma | 99% | 0.120 |
| Mannose | Sigma | 99% | 0.080 |

### Dissolving, Pulp Working Solution

Weigh each sugar separately to 4 significant digits and transfer to the same 200 mL volumetric flask. Dissolve sugars in a small amount of water. Take to volume with water, mix well, and transfer contents to two clean, 4-oz. amber bottles. Label and store in the refrigerator. Make working standards as in the following table.

PULP SUGAR STANDARD CONCENTRATIONS FOR DISSOLVING PULPS

| | | mL/200 mL | mL/200 mL | mL/200 mL | mL/200 mL | mL/200 mL |
|---|---|---|---|---|---|---|
| Fucose | | 0.70 | 1.40 | 2.10 | 2.80 | 3.50 |
| Sugar | mg/mL | ug/mL | ug/mL | ug/mL | ug/mL | ug/mL |
| Fucose | 60.00 | 300.00 | 300.00 | 300.00 | 300.00 | 300.00 |
| Glucose | 64.64 | 226.24 | 452.48 | 678.72 | 904.96 | 1131.20 |
| Xylose | 1.266 | 4.43 | 8.86 | 13.29 | 17.72 | 22.16 |
| Mannose | 0.8070 | 2.82 | 5.65 | 8.47 | 11.30 | 14.12 |

### Wood Pulp Stock Standard Solution

WOOD PULP SUGAR STANDARD CONCENTRATIONS

| Sugar | Manufacturer | Purity | g/200 mL |
|---|---|---|---|
| Fucose | Sigma | 99% | 12.00 |
| Rhamnose | Sigma | 99% | 0.0701 |

Dispense 1 mL of the fucose solution into a 200-mL flask and bring to final volume. Final concentration will be 0.3 mg/mL.

### Wood Pulp Working Solution

Use the Kraft Pulp Stock solution and the fucose and rhamnose stock solutions. Make working standards as in the following table.

PULP SUGAR STANDARD CONCENTRATIONS FOR KRAFT PULPS

| 2-Deoxy- | | mL/200 mL | mL/200 mL | mL/200 mL | mL/200 mL | mL/200 mL |
|---|---|---|---|---|---|---|
| D-glucose | | 0.70 | 1.40 | 2.10 | 2.80 | 3.50 |
| Sugar | mg/mL | ug/mL | ug/mL | ug/mL | ug/mL | ug/mL |
| 2-DG | 60.00 | 300.00 | 300.00 | 300.00 | 300.00 | 300.00 |
| Fucose | 0.300 | 1.05 | 2.10 | 3.15 | 4.20 | 6.50 |
| Arabinose | 0.36 | 1.2 | 2.5 | 3.8 | 5.00 | 6.508 |
| Galactose | 0.30 | 1.1 | 2.2 | 3.30 | 4.40 | 5.555 |
| Rhamnose | 0.3500 | 1.225 | 2.450 | 3.675 | 4.900 | 6.125 |
| Glucose | 24.00 | 84 | 168.0 | 252.0 | 336.0 | 420.7 |
| Xylose | 3.20 | 11 | 22.0 | 33.80 | 45.00 | 56.05 |
| Mannose | 2.80 | 9.80 | 19.0 | 29.0 | 39.0 | 49.07 |

### Procedure

### Sample Preparation

Grind 0.2±05 g sample with Wiley Mill 40 Mesh screen size. Transfer ˜200 mg of sample into 40-mL Teflon container and cap. Dry overnight in the vacuum oven at 50° C. Add 1.0 mL 72% H₂SO₄ to test tube with the Brinkman dispenser. Stir and crush with the rounded end of a glass or Teflon stirring rod for one minute. Turn on heat for Gyrotory Water-Bath Shaker. The settings are as follows:

### Heat: High

### Control Thermostat: 7° C.

Safety thermostat: 25° C.

### Speed: Off

### Shaker: Off

Place the test tube rack in gyrotory water-bath shaker. Stir each sample 3 times, once between 20-40 min, again between 40-60 min, and again between 60-80 min. Remove the sample after 90 mill. Dispense 1.00 mL of internal standard (Fucose) into Kraft samples. Tightly cover samples and standard flasks with aluminum foil to be sure that the foil does not come off in the autoclave.

Place a Comply SteriGage Steam Chemical Integrator on the rack in the autoclave. Autoclave for 60 minutes at a pressure of 14-16 psi (95-105 kPa) and temperature>260° F. (127° C.).

Remove the samples from the autoclave. Cool the samples. Transfer samples to the 200-mL volumetric flasks. Add 2-deoxy-D-glucose to wood samples. Bring the flask to final volume with water.

### For Kraft and Dissolving Pulp Samples:

Filter an aliquot of the sample through GRP 0.45μ filter into a 16-mL amber vial.

For Wood pulp Samples:

Allow particulates to settle. Draw off approximately 10 mL of sample from the top, trying not to disturb particles and filter the aliquot of the sample through GHP 0.45μ filter into a 16-mL amber vial. Transfer the label from the volumetric flask to the vial. Add 1.00 mL aliquot of the filtered sample with to 8.01 mL of water In the Dionex vial. Samples are run on the Dionex AS/500 system. See Chromatography procedure below.

### Chromatography Procedure

Solvent preparation

Solvent A is distilled and deionized water (118 meg-ohm), sparged with helium while stirring for a minimum of 20 minutes, before installing under a blanket of helium, which is to be maintained regardless of whether the system is on or off.

Solvent B is 400 mM NaOH. Fill Solvent B bottle to mark with water and sparge with helium while stirring for 20 minutes. Add appropriate amount of 50% NaOH.

(50.0 g NaOH/100 g solution)*(1 mol NaOH/40.0 g NaOH)*(1.53 g solution/1 mL solution)*(1000 mL solution/1 L solution)=19.1 M NaOH in the container of 50/50 w/w NaOH.

### 0.400 M NaOH*(1000 mL H₂O/19.1 M NaOH)=20.8 mL NaOH

Round 20.8 mL down for convenience:

19.1 M*(20.0 mL×mL) 0.400 M NaOH

x mL=956 mL

Solvent D is 200 mM sodium acetate. Using 18 meg-ohm water, add approximately 450 mL deionized water to the Dionex sodium acetate container. Replace the top and shake until the contents are completely dissolved. Transfer the sodium acetate solution to a 1-L volumetric flask. Rinse the 500-mL sodium acetate container with approximately 100 mL water, transferring the rinse water into the volumetric flask. Repeat rinse twice. After the rinse, fill the contents of the volumetric flask to the 1-L mark with water. Thoroughly mix the eluent solution. Measure 360±10 mL into a 2-L graduated cylinder. Bring to 1800±10 mL. Filter this into a 2000-mL sidearm flask using the Millipore filtration apparatus with a 0.45 pm, Type HA membrane. Add this to the solvent D bottle and sparge with helium while stirring for 20 minutes.

The postcolumn addition solvent is 300 mM NaOH. This is added postcolumn to enable the detection of sugars as anions at pH>12.3. Transfer 15±0.5 mL of 50% NaOH to a graduated cylinder and bring to 960±10 mL in water.

(50.0 g NaOH/100 g Solution)*(1 mol NaOH/40.0 g NaOH)*(1.53 g Solution/1 mL Solution) (1000 mL Solution/1 L solution)=19.1 M NaOH in the container of 50/50 w/w NaOH.

### 0.300 M NaOH*(100 ml H₂O/19.1 M NaOH)=15.7 mL NaOH

Round 15.7 mL down:
19.1 M*(15.0 mL/x mL)=0.300 M NaOH
x mL=956 mL
(Round 956 mL to 960 mL. As the pH value in the area of 0.300 M NaOH is steady an exact 956 mL of water is not necessary.)

Set up the AS 50 schedule.

Injection volume is 5 uL for all samples, injection type is “Full”, cut volume is 10 uL, syringe speed is 3, all samples and standards are of Sample Type “Sample”. Weight and Int. Std. values are all set equal to 1.

Run the five standards at the beginning of the run in the following order:

### STANDARD A1 DATE

### STANDARD B1 DATE

### STANDARD C1 DATE

### STANDARD D1 DATE

### STANDARD E1 DATE

After the last sample is run, run the mid-level standard again as a continuing calibration verification

Run the control sample at any sample spot between the beginning and ending standard runs.

Run the samples.

CALCULATIONS
Calculations for Weight Percent of the Pulp Sugars
$\text{Normalized} area for sugar = \frac{( Area sugar ) * ( μg \text{/} mL fucose )}{( Area Fucose )}$
$\begin{matrix}IS Corrected sugar amount ( μg \text{/} mL ) = \frac{\begin{matrix}( ( Normalized area for sugar ) - \\ ( intercept ) )\end{matrix}}{( slope )} \\ Monomer Sugar Weight \% = \frac{IS - Corrected sugar amt ( μg \text{/} mL )}{Sample wt . ( mg )} * 20 \\ \underline{\text{Example for arabinose:}} \\ Monomer Sugar Weight \% = \frac{0.15 μg \text{/} mL arabinose}{70.71 mg arabinose} * 20 = 0.043 \%\end{matrix}$
Polymer Weight % = (Weight % of Sample sugar) * (0.88)
Example for arabinan:
Polymer Sugar Weight % = (0.043 wt %) * (0.88) = 0.038 Weight
Note:
Xylose and arabinose amounts are corrected by 88% and fucose, galactose, rhamnose, glucose, and mannose are corrected by 90%. Report results as percent sugars on an oven-dried basis.

What is claimed is:

1. A method for processing a pulp comprising the steps of:
providing a pulp;
providing an ionic liquid;
said ionic liquid further comprising a cation and an anion;
dissolving said pulp in said ionic liquid to produce a solution,
spinning said solution to obtain fibers;
regenerating said fibers in a non solvent,
washing and drying said fibers; and
wherein said pulp has a hemicellulose level of at least 3.0% by weight in said pulp.

2. The method of claim 1 further comprising depositing said fibers on a moving foraminous surface to form a nonwoven web;
wherein said fibers in said nonwoven web are self bonded.

3. The method of claim 1 wherein said pulp is a bleached pulp.

4. The method of claim 1 wherein said pulp is an unbleached pulp.

5. The method of claim 1 wherein the weight percent pulp dissolved in the ionic liquid is from about 1 to 35.

6. The method of claim 1 wherein said pulp has a degree of polymerization of from about 150 to about 3000.

7. The method of claim 1 wherein the pulp has a ΔR from about 2 to about 10.

8. The method of claim 1 wherein the cation is selected from the group consisting of a cyclic cation and an acyclic cation.

9. The method of claim 8 wherein the cyclic cation in said ionic liquid is selected from the group consisting of pyridinium, imidazolium, and imidazole.

10. The method of claim 8 wherein the acyclic cation is selected from the group consisting of alkyl quaternary ammonium and alkyl quaternary phosphorous cations.

11. The method of claim 1 wherein the anion is selected from the group consisting of halogen, pseudohalogen and carboxylate.

12. The method of claim 11 wherein the carboxylate anion is selected from the group consisting of acetate, citrate, malate, maleate, formate, and oxylate.

13. The method of claim 11 wherein the halogen anion is selected from the group consisting of chloride, bromide, zinc chloride/choline chloride, 3-methyl-N-N-butyl-pyridinium chloride and benzyldimethyl (tetradecyl) ammonium chloride.

14. The method of claim 13 wherein the anion is chloride.

15. The method of claim 9 wherein the cyclic cation is the 1-ethyl-3methylimidazolium cation.

16. The method of claim 12 wherein the carboxylate anion is acetate.

17. The method of claim 1 wherein the cation is the 1-ethyl-3 methylimidazolium cation and the anion is acetate.

18. The method of claim 1 wherein the spinning method is selected from the group consisting of dry-jet-wet spinning, centrifugal spinning, meltblown spinning and spunbonding.

19. The method of claim 18 wherein the spinning method is meltblown spinning.

20. The method of claim 19 wherein the fibers obtained by meltblown spinning are characterized by a fiber diameter of from about 3μ to about 40μ.

21. The method of claim 19 wherein the fibers obtained by meltblown spinning are characterized by a birefringence of from about 0.01 to about 0.050.

22. The method of claim 19 wherein the fibers obtained by meltblown spinning are characterized by a hemicellulose level of at least 3.0 percent by dry weight in fiber.

23. Cellulose fibers characterized by a fiber diameter of from about 3μ to about 40μ wherein said fibers have a smooth surface and wherein said fibers are meltblown from an ionic liquid.

24. The fibers of claim 22 wherein the pulp used to form said fibers has a hemicellulose level of from about 3.0% by weight to about 18% by weight in said fiber.

25. The fibers of claim 22 characterized by a birefringence from about 0.01 to about 0.05.

26. A nonwoven product comprising cellulose fibers characterized by a hemicellulose level of at least 3.0% a birefringence of from about 0.010 to about 0.050 and wherein said cellulose fibers are meltblown from an ionic liquid.
